(19) United States
(12) Patent Application Publication
(10) Pub. No.: US 2009/0310783 A1
(43) Pub. Date: Dec. 17, 2009

(54) Controlled Dissemination of Information in Mobile Networks

(75) Inventors: Ravindranath Kokku, Monmouth Jct, NJ (US); Karthikeyan Sundaresan, Howell, NJ (US); Guofei Jiang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/371,976

(22) Filed: Feb. 17, 2009

Related U.S. Application Data
(60) Provisional application No. 61/060,713, filed on Jun. 11, 2008.

(51) Int. Cl. H04K 1/00; H04L 9/28

(52) U.S. Cl. 380/255; 705/66; 705/71

(57) ABSTRACT

The present invention discloses systems and methods for controlled dissemination of information in mobile networks using encrypted broadcasts that are decrypted at the device. An encryption key is generated corresponding to a particular category or granularity of information. The information is encrypted before it is broadcast to the sector. A user within the sector sends a key request across the network, in response to which the encryption key is sent to the user. The user can decrypt the encrypted information received in the broadcast. Additionally, a credit-checking mechanism may be employed to ensure that the user has sufficient credit to purchase the key. In one embodiment, the information to be disseminated is divided into a plurality of categories, wherein each category corresponds to a granularity of information. The encryption key is one in a set of encryption keys, each of said set of encryption keys being assigned to a particular hierarchical level corresponding to a particular granularity of information.

### RELATED APPLICATIONS

This application claims priority to U.S. Provisional Application 61/060,713, filed Jun. 11, 2008, the contents of which are hereby incorporated herein.

### FIELD OF THE INVENTION

The present invention relates to content delivery in mobile networks. Specifically, the present invention relates to fine-grain control of dissemination of information to mobile devices within a sector.

### BACKGROUND OF THE INVENTION

The mobile industry is witnessing exponential growth in the diversity and complexity of services offered by service providers. Mobile service is becoming geographically ubiquitous, service plans less expensive, and networks more robust. Improvements in technology combined with smaller devices having powerful processors means that mobile users expect these services to exploit the capabilities of the device.

Besides connectivity between mobile users, these services include targeted content delivery, information on demand, and local news/reports/information pertinent to the user based on their locations and usage patterns. For instance, an information generator can regularly acquire traffic information specific to a nation, region, neighborhood, or street. This information could be hosted on an application server in communication with the mobile network. The user installs an application on their device, and the application acts as an interface between the user and the information on the application server that is delivered via the mobile network. The user pays the mobile operator for a data plan to download the information, as well as to either the mobile operator or to the application service provider or a third party for the specific content, depending on the agreements in place.

An unforeseen problem in this exponential growth of potential services has been the unprecedented growth in numbers of subscribers/users of these services. Millions of subscribers downloading megabytes of text/graphics/audio/video put a tremendous burden on mobile operators to ensure reliability in their network. Particularly, the cellular base station's communication with the user device is important, analogous to the “last mile” of internet service providers. Basically, large concentrations of users within a single cell or sector (an area served by a directional antenna on a base station servicing one or more cells) download similar content. This is especially true in the case of geographically relevant information, such as traffic or weather data. In addition to the bandwidth of a base station becoming overwhelmed, power usage increases, both at the base station and at the user device. Further, interference and fading effects lower the quality of the individual channel between a device and the base station, resulting in customer dissatisfaction.

Another potential waste of bandwidth is caused by packaging the same information to several subscribers who may actually have different needs. A subscriber may be loathe to pay for an entire traffic+weather package, whereas another subscriber may want more detailed traffic information and would be willing to pay more for the service. This also results in customer dissatisfaction.

To avoid the myriad problems associated with disseminating information to each user via individual channels, what is needed is a way to control dissemination of information in mobile networks in a way that is secure and efficient.

### SUMMARY OF THE INVENTION

To address the problems described above, the present invention discloses systems and methods for controlled dissemination of information in mobile networks using encrypted broadcasts that are decrypted at the device. An encryption key is generated corresponding to a particular category or granularity of information. The information is encrypted before it is broadcast to the sector. A user within the sector sends a key request across the network, in response to which the encryption key is sent to the user. The user can decrypt the encrypted information received in the broadcast.

Additionally, a credit-checking mechanism may be employed to ensure that the user has sufficient credit to purchase the key. This mechanism may invoke a billing subsystem on the mobile network. Users with insufficient credit are unable to decrypt the information. This ensures that unauthorized user devices within a sector will have to pay before being able to view the broadcasted information.

In one embodiment, the present invention is a system for controlling dissemination of information to a device on a mobile network, the system comprising an information generation unit for generating information to be disseminated over the mobile network, a key generator for generating an encryption key to be transmitted to the information generation unit, an encryption unit in communication with the information generating unit and the key generator for encrypting the information using the encryption key, and a broadcasting unit for broadcasting the encrypted information to the device across the mobile network.

Either the information generation unit or the encryption unit divides the information into a plurality of categories, wherein each category corresponds to a granularity of information. The encryption key is one in a set of encryption keys, each of said set of encryption keys being assigned to a particular hierarchical level corresponding to a particular granularity of information.

The system further comprises a transceiver on the device for transmitting a key request to the key generator and for retrieving a subset of the set of encryption keys from the key generator in response to the key request, and a decryption unit for decrypting the corresponding encrypted granularity of information received at the device.

Each encryption key is assigned a credit value based on the hierarchical level of the encryption key, the system further comprising a credit manager unit in communication with the key generator, said credit manager storing a first user account for a user of the device, wherein the key generator transmits a credit request to the credit manager to determine if the user has enough of a plurality of credits in said first user account to retrieve the requested subset of encryption keys.

The encryption key may be changed at fixed intervals.

In another embodiment, the present invention is a method for controlling dissemination of information to a device on a mobile network, the method comprising dividing the information into a plurality of categories, each of said plurality of categories corresponding to a granularity of information, generating a set of encryption keys, each of said encryption keys in the set being assigned to a particular hierarchical level among a plurality of hierarchical levels, said particular hierarchical level corresponding to a particular granularity of information, encrypting each category of information within a granularity of information with one of the set of encryption keys in the corresponding hierarchical level, and broadcasting the plurality of encrypted categories of information to the device on the mobile network.

The method further comprises transmitting, from the device, a key request to retrieve a subset of the set of encryption keys, transmitting the requested subset of encryption keys to the device, and using the requested subset of encryption keys to decrypt the corresponding category of information received at the device.

The method further comprises assigning a credit value to each encryption key within the set of encryption keys; in response to the key request, determining if an account associated with the device has sufficient credit to acquire the requested subset of encryption keys, and transmitting the requested subset of encryption keys to the device if there is sufficient credit in the account.

The method further comprises generating, at a first server in communication with the mobile network, the information to be disseminated. The method further comprises defining a broadcast sector on the mobile network, wherein the broadcast sector is serviced by one or more cellular base stations, and transmitting sector information to the first server, wherein the information to be disseminated is divided into categories based on the received sector information.

In another embodiment, the present invention is a system for disseminating information to a device on a mobile network, the system comprising means for generating information to be disseminated, means for dividing the information to be disseminated into a plurality of granularities, means for generating a set of encryption keys, wherein each encryption key is assigned a particular hierarchy corresponding to one of the plurality of granularities, means for encrypting the one of the plurality of granularities of information using said corresponding encryption key, and means for broadcasting the plurality of granularities to the device across the mobile network.

The system further comprises means for receiving a key request for a subset of the set of encryption keys from the device on the mobile network, means for transmitting the requested subset of encryption keys to the device, and means for decrypting the broadcasted encrypted granularities received at the device.

### BRIEF DESCRIPTIONS OF THE DRAWINGS

FIG. 1 shows a system for controlled dissemination of information, according to an exemplary embodiment of the present invention.

FIG. 2 shows alternate methods for generating and encrypting information, according to an exemplary embodiment of the present invention.

FIG. 3 shows method steps for encrypting and broadcasting information, according an exemplary embodiment of the present invention.

FIG. 4 shows method steps for decrypting information received at a device, according to an exemplary embodiment of the present invention.

FIGS. 5A and 5B show different ways of dividing information into granularities, according to two respective embodiments of the present invention.

### DETAILED DESCRIPTION OF THE INVENTION

The present invention discloses systems and methods for controlled dissemination of information in mobile networks using encrypted broadcasts that are decrypted at the device. An encryption key is generated, and the information is encrypted before it is broadcast to the particular sector. A user within the sector sends a key request across the network, in response to which the encryption key is sent to the user. The user can decrypt the encrypted information received in the broadcast. A credit-checking mechanism may be employed to ensure that the user has sufficient credit to purchase the key.

For the purposes of the present disclosure, a device is any electronic device with the ability to connect to a wireless network. Representative devices include mobile phones, PDAs, computers with mobile connectivity, or any device with a transceiver operable to communicate with a mobile network.

A mobile network includes but is not limited to a wireless communications network operated by a service provider or “operator.” Mobile networks can use cellular technology, as well as other radio and packet-based technology. Representative mobile networks include 2G and 3G networks as well as current and future equivalents, such as IP Multimedia System (IMS) and High-Speed Downlink Packet Access (HSDPA).

A server is a hardware or software implementation of a means for providing a service on the mobile network. Servers can include one or more central processing units (CPU), memory, storage devices, and network connectivity. Servers can be placed at several points in the mobile network. For instance, an Application Server (AS) hosts a particular information-providing service, and can communicate the information across the network to a device that has requisite software installed on it. An AS may include an Information Generator (IG) unit that generates the information to be hosted by the AS, or the IG may be a separate server in communication with the AS. Other examples include Key Generators, Credit Managers, Billing Servers, etc. and will be described herein.

Encryption units, decryption units, etc. are software instructing a processor to perform the described task, or hardware implementations of the corresponding set of instructions. These may be embedded in hardware, or stored in a memory.

A cell is a geographical unit that is serviced by one or more cell sites, commonly known as Base Stations (BS). A BS has a plurality of directional antennae that point radially outwards, servicing a “sector.” A sector is a part of a cell that may be served by one or more antennae from different base stations. Although the present invention is described in terms of broadcasting information to a particular sector, this is not necessarily the case, and a person of ordinary skill in the art will be able to apply the present invention to different geographic units/configurations depending on the chosen implementation.

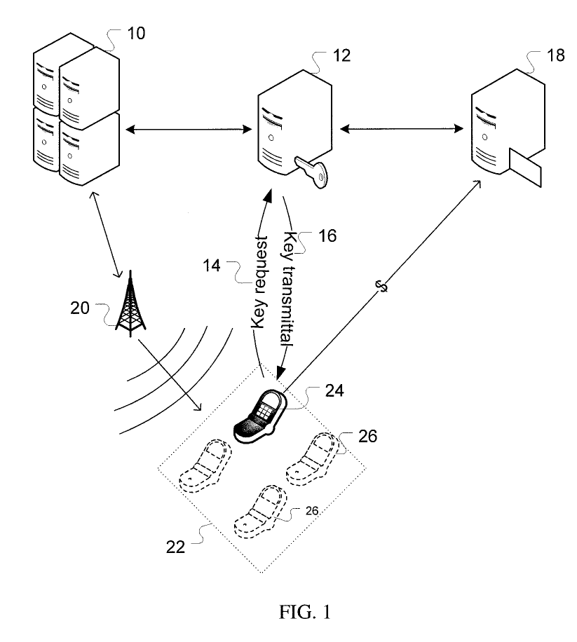

The present invention can be realized in the exemplary embodiment represented in FIG. 1, showing a system for controlled dissemination of information. Application server or Information Generator (IG) 10 is in communication with Key Generator (KG) 12, and can transmit information via network elements (not shown) to Base Station (BS) 20. BS 20 has a directional antenna (not shown) that services a sector 22. Sector 22 includes device 24, as well as other devices 26. Further, a Credit Manager Unit (CM) 18 is on the mobile network and in communication with KG 12.

IG 10 may be a part of an application server suite, or a standalone unit in communication with an externally-operated application server suite (not shown). IG 10 may be operated by the mobile network operator, the application service provider, or a third party service provider. In either case, the purpose of IG 10 is to generate and/or assimilate the content to be broadcasted to sector 22. For instance, IG 10 receives the latest traffic information from a plurality of application servers or externally operated databases such as a government traffic database, or even local radio/TV traffic databases, depending on agreements between the entities. IG 10 collects and categorizes the information into a form that is relevant to the devices in sector 22. IG 10 receives sector information from BS 20, and is able to divide the information to be disseminated corresponding to the sector information received from BS 20.

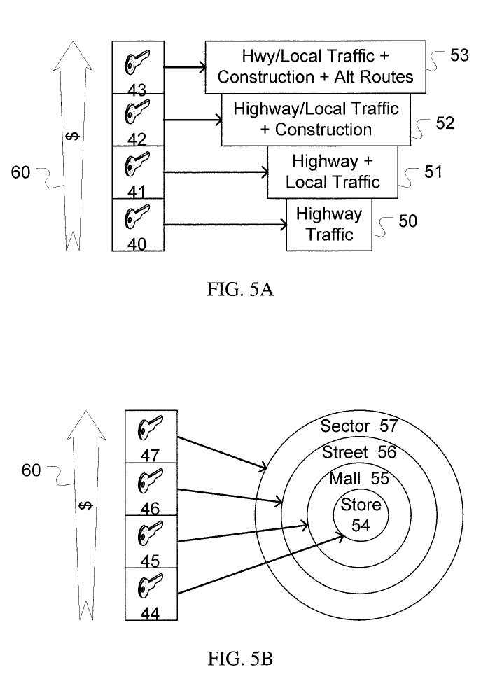

IG 10 is also in communication with KG 12. KG 12 generates one or more encryption keys, and sends the encryption keys to IG 10. IG 10 correspondingly encrypts the information to be disseminated, before broadcasting via BS 20. KG 12 may include a key database (not shown) to store a plurality of predetermined encryption keys, or sets of encryption keys. The encryption keys may be assigned to hierarchical levels or “hierarchies” depending on the value of the information they are used to encrypt. This feature is further described below and in reference to FIGS. 5A and 5B.

KG 12 also includes a transceiver for receiving, via the mobile network, a Key Request 14 from device 24. Device 24 transmits the key request in order to access an encryption key, or a subset of the set of encryption keys, depending on the information requested by a user of device 24. The key request may alternatively request the particular information required by the user, and KG 12 has to find the associated subset of keys. Alternatively the user simply requests a granularity of information via an application on the device 24, and the application corresponds with KG 12 to determine the required subset of encryption keys. The relationship between the subset of encryption keys requested, and the information to be disseminated, is further described below. The transceiver within KG 14 is able to transmit the subset of encryption keys 16 requested by the device across the mobile network. The receipt of the key request 14 and the transmittal 16 can be done over a designated individual channel between the mobile network and the device 24. This necessarily requires the Key Request 14 to include a unique identifier of device 24, such as a User ID, MSISDN, SIP address, etc. This is in contrast to the broadcast method for broadcasting the information to be disseminated to the sector. Because the key is transmitted over an individual channel, and ideally uses less bandwidth than the encrypted information to be disseminated, overall bandwidth usage is reduced, and control is maintained over who can view the broadcasted information.

In response to the key request 14, KG 12 is able to check a user account associated with the device 24, to ensure that there is sufficient credit in the user's account to purchase the encryption key. A request may be transmitted from KG 12 to a Credit Manager Unit (CM) 18. CM 18 includes a database (not shown) for storing an account for each subscriber of the mobile network who wishes to purchase access to broadcasted information. CM 18 refers to the account, and reports back to KG 12 with information on whether or not there are sufficient credits in the account. If there is sufficient credit, KG 12 approves the key request 14 and initiates a key transmittal 16 to the device 24. KG 12 may also debit the account based on the price of the requested subset of encryption keys, or may instruct CM 18 to do so. If there is insufficient credit, KG 12 may deny the request and inform the user at device 24 of insufficient funds. Once the key transmittal 16 is received by device 24, a decryption unit within device 24 decrypts the received broadcasted information.

For the purposes of the present invention, “credits” may comprise a virtual currency, corresponding to the value of the encryption keys requested, or simply a dollar value corresponding to the amount of funds the user has in a user account. In this case, CM 18 may further invoke a billing subsystem to access the user account. The billing subsystem may be operated by the network operator, or a third party. The user is able to provision funds into his user account via the billing subsystem on the mobile network. CM 18 would instruct the billing system to debit the user account based on the credits purchased. This feature may be realized in a pre-paid or post-paid system, whereby the credits purchased by a user via CM 18 may be added to a user's monthly phone bill. CM 18 is therefore a scalable entity that can be part of the mobile operator's network, or the application service provider's network, so long as communication is maintained between CM 18 and a user account, and between CM 18 and KG 12.

The plurality of keys within the set of keys can be assigned to particular types, categories, or “granularities” of information generated at IG 10. Since BS 20 is broadcasting several different categories of information to sector 22, it is conceivable that users of devices 24 and 26 may not all want the same information. Thus, IG 10 further includes the ability to divide the information into several predetermined categories, based on parameters provided by the application service provider, mobile network operator, or any third party in control of the information to be disseminated. In one exemplary embodiment, the information can be divided into categories based on sector information received from BS 20. An application server or IG 10 server requests information on broadcast sectors. BS 20 (as part of the mobile operator's network) provides IG 10 with broadcast resources, including information pertinent to all defined broadcast sectors. IG 10 uses the information about broadcast sectors derived from the network operator to granulate/divide the information to be disseminated. For instance, weather information can be assigned per sector. Correspondingly, KG 12 generates a set of encryption keys, each of which is pertinent to a particular sector. The user can then submit key request 14 requesting encryption keys associated with the corresponding granularity of information relevant to that sector. The encryption keys can further be assigned to hierarchies based on the granularity of information, and priced based on these hierarchies. This allows for fine-grain offerings of information services to users, with corresponding pricing schemes. Other examples of dividing information and pricing keys are described herein with respect to FIGS. 5A and 5B below.

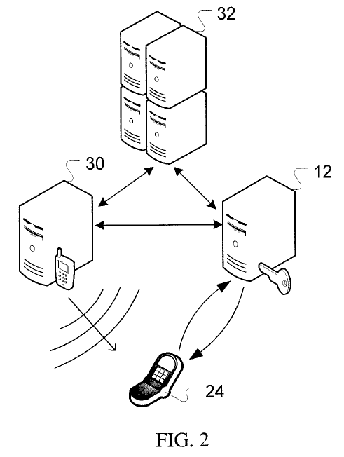

As described, the connectivity and scalability of network elements in today's mobile networks allows for several configurations of Application Servers and Information Generators. FIG. 2 shows how information can be generated and encrypted in different ways, according to an exemplary embodiment of the present invention. In FIG. 2, AS 32 is in communication with KG 12, as well as an Information Aggregator (IA) 30. IA 30 may be a server owned and operated by the network operator, or by a third party aggregation service. AS 32 may further include a plurality of application servers operated by one or more application service providers. Thus, IA 30 can aggregate information provided by a plurality of application servers.

The encryption of the information to be disseminated can be performed at the AS 32, or at the IA 30, or a combination of the two. In one embodiment, AS 32 receives a set of encryption keys generated by KG 12, divides and encrypts the information, and transmits the categorized encrypted information to IA 30. IA 30 may further receive categorized encrypted information from other application servers, before disseminating (broadcasting) the information to device 24. Alternatively, AS 32 may simply generate information and transmit the raw data to IA 30. In this exemplary embodiment, IA 30 receives raw data from one or more application servers 32, and categorizes and encrypts the information, based on the set of encryption keys received from KG 12. As described above, IA may also receive broadcast sector information from the network, thereby assisting in dividing the information based on broadcast sectors. Alternatively, a combination of dividing and encrypting may occur at both AS 32 and IA 30, before the encrypted information is broadcasted to device 24.

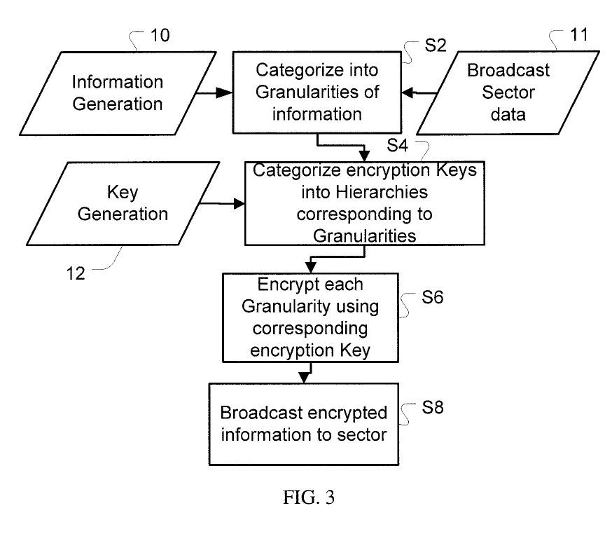

FIG. 3 shows a method steps for encrypting and broadcasting information, according an exemplary embodiment of the present invention. Information generation 10, broadcast sector data 11, and Key generation 12 are respectively performed by IG 10, BS 10 and KG 12. The steps are represented by the references S2-S8. In step S2, an application server, an information aggregator, or combination of the two categorizes the information into a plurality of granularities. This process may use the broadcast sector data 11 to generate granularities of information relevant to geographical sectors.

At step S4, a set of encryption keys is generated by KG 12, and the encryption keys are categorized into hierarchies, corresponding to the granularities of information in S2. For instance, a particular encryption key in one hierarchy may correspond to a particular piece of information in one granularity. This enables a service provider to offer fine-grained model of charging for increments of information, and is further described with respect to FIGS. 5A and 5B.

At step S6, each granularity of information is encrypted with the corresponding encryption key. This step may be performed at IG 10, AS 32, IA 30, or any combination of the three, as described above. Once the information to be disseminated is encrypted, it is broadcast via the mobile network at step S8. The encrypted packets of information traverse the mobile network, possibly via packet-based protocol such as IP, before arriving at one or more of BS 10, at which point they are assigned to a particular sector antenna and broadcast to all devices within that sector.

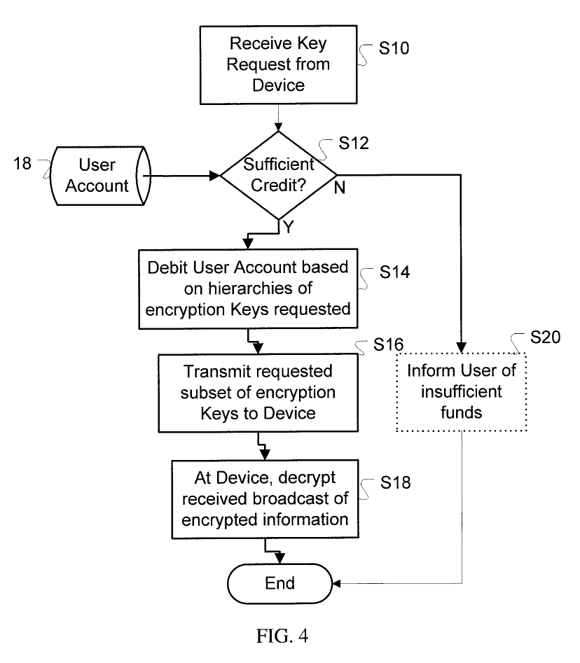

FIG. 4 shows method steps for decrypting information received at a device, according to an exemplary embodiment of the present invention. At step S10, either KG 12 or an equivalent entity on the mobile network receives a key request 14 from device 24. As described above, this key request is securely transmitted over a designated individual channel, and includes a unique identification for the user, as well as an indication of the requested subset of keys or the particular granularity of information requested. In addition, the each encryption key is assigned to a particular hierarchy, and further assigned a value depending on the value of the corresponding granularity of information. Therefore, KG 12 determines the total value of the requested subset of encryption keys in terms of credits, and initiates a credit check to determine if the user has sufficient credit, in step S12. Credit information from an account of the user, either from CM 18, or from a user account on a billing subsystem, is retrieved.

If sufficient credit exists, the key request is approved, the account is debited corresponding to the amount of credit for the requested subset of keys in step S14, and the subset of encryption keys is transmitted to the device 24 in step S16. At step S18, the device receives, via the individual channel, the requested subset of encryption keys. The device is already receiving several broadcasted encrypted granularities of information, but is only able to decrypt the granularities corresponding to the received subset of encryption keys. This ensures that only information that is purchased is actually viewed by the user. Following a determination in step S12 that the user does not have sufficient credit in the user account, an optional step S20 informs the user that there is insufficient credit, and denies the key request.

Another feature of the present invention, as mentioned herein, is the ability to divide information into a plurality of categories, or “granularities” and to encode the different granularities of information using a different key for each granularity. The information can be divided in a number of ways. FIG. 5A shows one scheme for generating granularities of information, related to traffic data. Several types of traffic data may be generated at IG 10, or received at IA 30 from a plurality of application servers 32. This information can be divided into several granularities, based on, for instance, detail as to geographic relevance. In FIG. 5A, four granularities of information 50-53 are shown, in increasing order of detail. Traffic on highways within the sector is assigned to granularity 50. Traffic pertinent to highways and local roads within the sector is assigned to granularity 51. The same information, along with construction delays and related information is assigned to granularity 52. Finally, recommendations of alternate routes can be added to granularity 53.

Each granularity is encrypted with a separate encryption key, a set of which is represented by keys 40-43, respectively corresponding to granularities 50-53. Furthermore, each encryption key is assigned a hierarchy based on the granularity, wherein each hierarchy is assigned a corresponding value of credits. The changing width of arrow 60 indicates increasing value per encryption key as the information gets more detailed. This allows users to pay different amounts for the different information services purchased.

For instance, a user of device 24 may request, via a software application on device 24, one or more granularities of information, such as Highway+Local traffic. The application, maintaining 1-to-1 communication with the mobile network, requests a subset of encryption keys, comprising the two keys 40 and 41. Each encryption key may be used to decrypt separate granularities, or encryption key 41 may be used to decrypt both granularities 50 and 51. The combinations will depend on how the information was encrypted in the first place. Fewer encryption keys lead to fewer connections, therefore less bandwidth and processing power, however, a somewhat complex configuration of encryption keys can facilitate fine-grain charging control.

In either case, another user who requests more information, i.e. Highway+Local traffic including construction information, would place an order for granularity 52, or alternatively, granularities 50-52. Again, the specific combination would depend on the categorization and encryption used by the application service provider. In either case, the application on user's device 24 places a request for encryption key 42, or 40-42, and subject to credit approval, receives the particular granularities of information. This time the user pays more for the additional information.

Besides the “increasing detail” granularities of FIG. 5A, several other division schemes can be realized by the present invention. Another scheme could represent varying “scope of information” within the granularities, as represented by FIG. 5B. The concentric circles 54-60 represent sale or pricing information about a particular product or group of products. This information could include deals, such as Black Friday or Boxing Day deals, depending on the application service provider. In this exemplary embodiment, granularities 54-60 represent the different search zones or locations where the deals can be found. For instance, granularity 54 searches for the cheapest item within a particular store or chain of stores. Granularity 55 expands the deal search to the entire mall in which the store is found. Granularity 56 expands the search to a street or neighborhood, and granularity 57 expands the search to find the cheapest one of a specified product in the entire sector 22.

Keys 44-47 correspondingly encrypt/decrypt granularities 54-60. Since the information having a greater search zone or “scope” is probably harder to acquire, requires more bandwidth, and is probably more valuable to the user, increased value is assigned to the higher-numbered keys, represented by arrow 60. Therefore, a user who wishes to scan the mall for deals purchases granularity 55 (corresponding to encryption key 45), whereas a user who wishes to scan the neighborhood for deals pays more credits by purchasing granularity 57 (corresponding to encryption key 57). This allows a network operator or application service provider to exercise fine-grained pricing controls on their information to be disseminated, thereby providing better value for their services while saving on bandwidth and processing costs.

Several other similar categorization mechanisms will be apparent to one skilled in the art, such as receiving parking information priced according to the demand for parking in a particular sector. Further, the credit account stored in CM 18 can be applied to purchase information from a plurality of application servers operated by different providers, based on contractual relationships. Further, service providers can organize, price, and disseminate granularities of information via separate broadcasting mechanisms in different sectors, depending on the population, income levels, etc.

In addition, while preferred embodiments of the present invention have been described using specific terms, such description is for illustrative purposes only, and it is to be understood that changes and variations may be made without departing from the spirit or scope of the following claims.

1) A system for controlling dissemination of information to a device on a mobile network, the system comprising:
an information generation unit for generating information to be disseminated over the mobile network, wherein the information generation unit divides the information into a plurality of categories corresponding to a plurality of granularities of information;
a key generator for generating an encryption key to be transmitted to the information generation unit, said encryption key being one in a set of encryption keys, each encryption key of the set being assigned to a particular hierarchical level corresponding to a particular granularity of information;
an encryption unit in communication with the information generating unit and the key generator for encrypting the particular granularity of information using the corresponding encryption key; and
a broadcasting unit in communication with the information generation unit for broadcasting the encrypted information to the device across the mobile network

2) The system of claim 1, further comprising:
a transceiver on the device for transmitting a key request to the key generator and for retrieving a subset of the set of encryption keys from the key generator in response to the key request; and
a decryption unit on the device for decrypting the corresponding encrypted granularity of information received at the device.

3) The system of claim 2, wherein the key request and the encryption key are transmitted over a designated channel between the device and the mobile network.

4) The system of claim 1, wherein each encryption key is assigned a credit value based on the hierarchical level of the encryption key, the system further comprising a credit manager unit in communication with the key generator, said credit manager unit storing a first user account for a user of the device, wherein the key generator transmits a credit request to the credit manager unit to determine if the user has enough of a plurality of credits in said first user account to retrieve the requested subset of encryption keys.

5) The system of claim 4, further comprising: a billing system in communication with the credit manager unit, wherein the credit manager unit refers to a second user account in the billing system to determine availability of the plurality of credits.

6) The system of claim 5, further comprising means for adding credits to the user account by purchasing the plurality of credits from an operator of the mobile network, an application service provider, or a third party service provider.

7) The system of claim 4, further comprising means for adding credits to the user account by purchasing the plurality of credits from a provider of the information to be transmitted.

8) The system of claim 1, further comprising: one or more cellular base stations for serving a broadcast sector, said one or more cellular base stations transmitting broadcast sector information to the information generation unit.

9) The system of claim 8, wherein the information generation unit or the encryption unit divides the information to be disseminated into categories based on the received broadcast sector information, encrypts the information to be disseminated, and broadcasts the encrypted information to be disseminated to a plurality of devices in the broadcast sector.

10) The system of claim 1, wherein the information generation unit is one of a plurality of application servers, each application server from said plurality of application servers generating information to be disseminated, the system further comprising: an information aggregator to receive from the plurality of application servers the information to be disseminated, divide the information into said plurality of information categories, and encrypt the plurality of categories of information.

11) The system of claim 1, wherein the key generator changes the encryption key at fixed intervals.

12) A method for controlling dissemination of information to a device on a mobile network, the method comprising:
dividing the information into a plurality of categories, each of said plurality of categories corresponding to a granularity of information;
generating a set of encryption keys, each of said encryption keys in the set being assigned to a particular hierarchical level among a plurality of hierarchical levels, said particular hierarchical level corresponding to a particular granularity of information;
encrypting each category of information within a granularity of information with one of the set of encryption keys in the corresponding hierarchical level; and
broadcasting the plurality of encrypted categories of information to the device on the mobile network.

13) The method of claim 12, further comprising:
transmitting, from the device, a key request to retrieve a subset of the set of encryption keys;
transmitting the requested subset of encryption keys to the device; and
using the requested subset of encryption keys to decrypt the corresponding category of information received at the device.

14) The method of claim 13, wherein the key request and the encryption key are transmitted over an individual channel between the device and the mobile network.

15) The method of claim 13, further comprising:
assigning a credit value to each encryption key within the set of encryption keys;
in response to the key request, determining if an account associated with the device has sufficient credit to acquire the requested subset of encryption keys; and
transmitting the requested subset of encryption keys to the device if there is sufficient credit in the account.

16) The method of claim 15, wherein the credit value of each encryption key is based on the particular hierarchical level of the encryption key.

17) The method of claim 15, wherein the credit in the account associated with the device corresponds to an amount of funds available in a user account associated with the device.

18) The method of claim 17, further comprising: adding credits to the account associated with the device by submitting a request, wherein the user account is debited proportionate to the credits requested.

19) The method of claim 18, further comprising: invoking a billing subsystem to determine if the user account has sufficient funds corresponding to the credit value of the requested set of encryption keys, before transmitting said requested set of encryption keys to the device.

20) The method of claim 12, further comprising: generating, at a first server in communication with the mobile network, the information to be disseminated.

21) The method of claim 20, further comprising:
defining a broadcast sector on the mobile network, wherein the broadcast sector is serviced by one or more cellular base stations; and
transmitting sector information to the first server, wherein the information to be disseminated is divided into categories based on the received sector information.

22) The method of claim 21, further comprising: broadcasting the plurality of encrypted categories of information to a plurality of devices within the broadcast sector.

23) The method of claim 21, wherein the first server is one of a plurality of application servers, each of said plurality of application servers generating information to be disseminated, the method further comprising:
transmitting the information to be disseminated to an information aggregator;
dividing, at the information aggregator, the information into said plurality of information categories based in part on the received sector information; and
broadcasting the encrypted plurality of categories of information to a plurality of devices within the broadcast sector.

24) The method of claim 12, further comprising: changing the encryption key corresponding to the particular information granularity at fixed intervals.

25) The method of claim 24, further comprising: requesting at said fixed intervals, from the device, the changed encryption key corresponding to the particular information granularity.

26) The method of clam 13, wherein the step of transmitting a key request further comprises:
initiating, via an application installed on the device, a request for a particular category of information; and
generating a request for an encryption key associated with the particular category of information.
